(19) United States
(12) Patent Application Publication
(10) Pub. No.: US 2004/0024659 A1
(43) Pub. Date: Feb. 5, 2004

(54) Method and apparatus for integrating server management and parts supply tools

(76) Inventors: Tisson Mathew, Hillsboro, OR (US); Chetan Hiremath, Hillsboro, OR (US)

Correspondence Address: KENYON & KENYON, 333 W. San Carlos Street, Suite 600, San Jose, CA, 95110-2711, US

(21) Appl. No.: 10/207,983

(22) Filed: Jul. 31, 2002

(51) Int. Cl. G06F 17/60

(52) U.S. Cl. 705/28; 705/26

(57) ABSTRACT

A method and apparatus for performing an administrative and maintenance task, in a multi-component system, is provided. The apparatus includes a plurality of components performing different operations. One of the plurality of components monitors the operations of the other components and determines if there is a component operating improperly. When a malfunctioning component is detected, the apparatus locates information associated with the malfunctioning component and automatically generates an order at a supplier and maintenance service.

### BACKGROUND OF THE INVENTION

Embodiments of the present invention generally relate to methods and apparatus for performing administrative and maintenance tasks in computer platforms. More particularly, the embodiments relate to methods and apparatus for integrating server management functions with event diagnosis operations and a customer support applications to permit a computer system to order parts and supplies autonomously.

Modern computer platforms are built from multiple components, such as integrated circuits (processors, memories and bridge interfaces), disk controllers, monitors, fans, power supplies and the like. Computer platforms often execute operating system software, which includes a management subsystem (herein “manager”) to observe component operation and identify operational abnormalities. Managers may be provided for relatively small computer systems, such as laptop computers and personal computers, for larger multiprocessor systems such as servers, and for networked computing platforms such as local area networks and wide area networks. The manager monitors the operations and conditions of the components including temperature, voltages, fans, memories, power supplies, and the like. Typically, communication protocols are defined to convey this information between the individual components and the manager. The Intelligent Platform Management Interface (IPMI) is an example of one such protocol. See. Intelligent Platform Management Interface Specification v1.5, doc. revision 1.0, Intel Corp., et al. (Feb. 21, 2001). IPMI defines standardized and abstracted interfaces to the platform management component. IPMI includes the definition of interfaces for extending platform management between components within a single chassis or multiple chassis.

Each component has predetermined operating parameters defined for it that constitute normal operation of the component. Thus, abnormal operation occurs when the performance of a component falls outside of these pre-established operating parameters or thresholds. The manager periodically monitors the components to determine whether they are operating adequately. If abnormal operation is detected, the manager typically generates an alert to a system administrator indicating such a faulting condition (or an error). Severe operating errors can be reported to administrative personnel, who typically evaluate, diagnose and repair system errors manually. Of course, such efforts can cause replacement of faulty components. For example, upon a notification from the system, the system administrator may determine that a server's fan is defective. The administrator may generate an order for a new fan to replace the damaged fan, which is a component of an operating system.

Such a task, however, may be tedious, time consuming, unreliable and expensive. It is tedious because the system administrator typically must be present physically at the location of a failing component to identify the make and model of the component. It is time consuming because the system administrator must manually enter parts data such as manufacturer and product information. It is unreliable because manual data entry is susceptible to errors; errors may cause wrong parts being ordered and increase system down time and overall cost. The task of manually acquiring parts data could also be difficult if the information is not readily available (i.e., if the component is mounted in a rack of enterprise server environments). It is expensive because support personnel must be hired to collect this information—if a component failure occurs during a time when support personnel are not present, the failure will go unnoticed until support personnel return to the system. Additionally, manual diagnosis and repair can result in poor maintenance habits. Some support personnel may be disinclined to repair failing components until they have failed completely. By pushing the useful life of a component, they risk significant system downtime when the component is unusable. So manual parts replacements lead to higher total cost of ownership (TCO).

From the foregoing, the inventors identified a need in the art for an automated server management service for computer platforms that diagnoses component failures and automatically orders replacement components, which eliminates the need for manual supervision of the platform.

### BRIEF DESCRIPTION OF THE DRAWINGS

FIG. 1 is a software diagram of a server management apparatus in accordance with one embodiment of the present invention;

FIG. 2 is a flow diagram of the server management apparatus in accordance with one embodiment of the present invention;

FIG. 3 is a block diagram of a multi-component system implementing the server management apparatus in accordance with one embodiment of the present invention;

FIG. 4 is a system diagram of an operating system implementing the server management apparatus in accordance with one embodiment of the present invention; and

FIG. 5 is a flow diagram depicting a method for building a central database adapted by the server management apparatus in accordance with one embodiment of the present invention.

### DETAILED DESCRIPTION

Embodiments of the present invention provide, in a multi-component system, methods and apparatus for integrating server management functions with component diagnosis operations and support applications that cause replacement parts and supplies to be ordered autonomously. A manager within a computer platform monitors the operations of the other components and determines if any component is operating improperly. When a malfunctioning component is detected, the apparatus locates information associated with the malfunctioning component and automatically generates an order with a supplier and maintenance service.

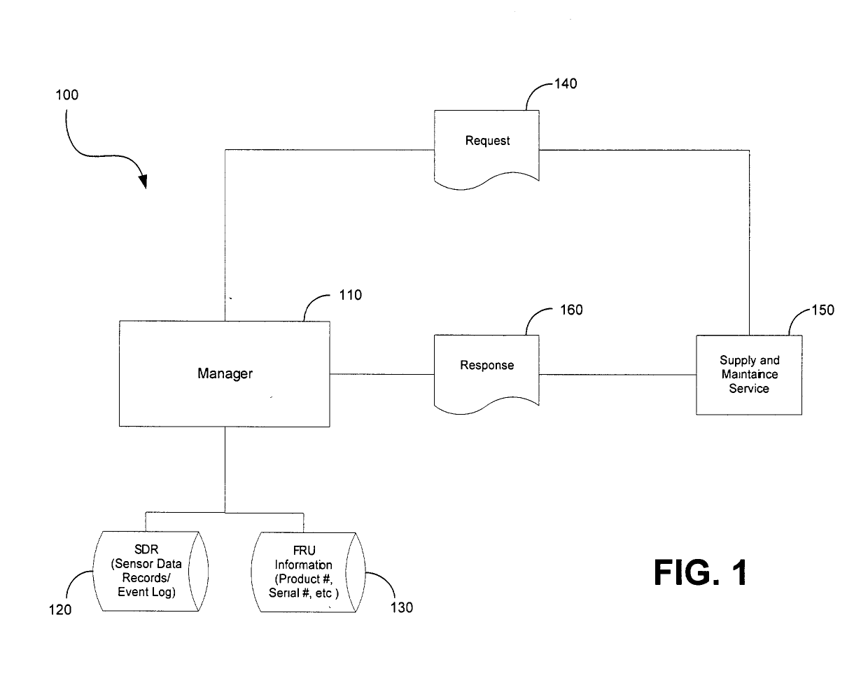

FIG. 1 is a software diagram depicting the architecture of an automated ordering system 100, in accordance with embodiments of the present invention. The system 100 may interface with a plurality of components or agents within a larger computer platform. In accordance with one embodiment of the invention, the system 100 may also include a manager 110, a sensor data record 120, and a field replacement unit information (FRU information) 130. The system 100 may be provided in communication with a supply and maintenance service 150 via communication links. Examples of communication between the apparatus 100 and the supply and maintenance service 150 may include a request 140 and a response 160.

The manager 110, as its name implies, is dedicated to management of the computer platform. It can control operation of the platform and may field reports from various platform components that indicate malfunctions of varying degrees. The managers 110 may build a sensor data record 120 from these reports over time and may log all reports or possibly just the most severe reports into an event log (the “event log” and/or “sensor data record” collectively are identified as 120). The managers 110 also may have access to a field replacement unit information 130, which may maintain information regarding a number of components within the server such as manufacturer and product information, product number, serial number, and the like.

The supply and maintenance service (SMS) 150 represents a second computer platform typically associated with a vendor of platform components. The SMS 150 accepts product orders from various sources, such as browser form-enabled documents, e-mailed requests, paged requests and the like. In the example of FIG. 1, the SMS 150 is shown as exchanging XML/HTML documents with the managers 110. A request 140 is shown propagating toward the SMS 150 and a response 160 is shown propagating back from the SMS 150.

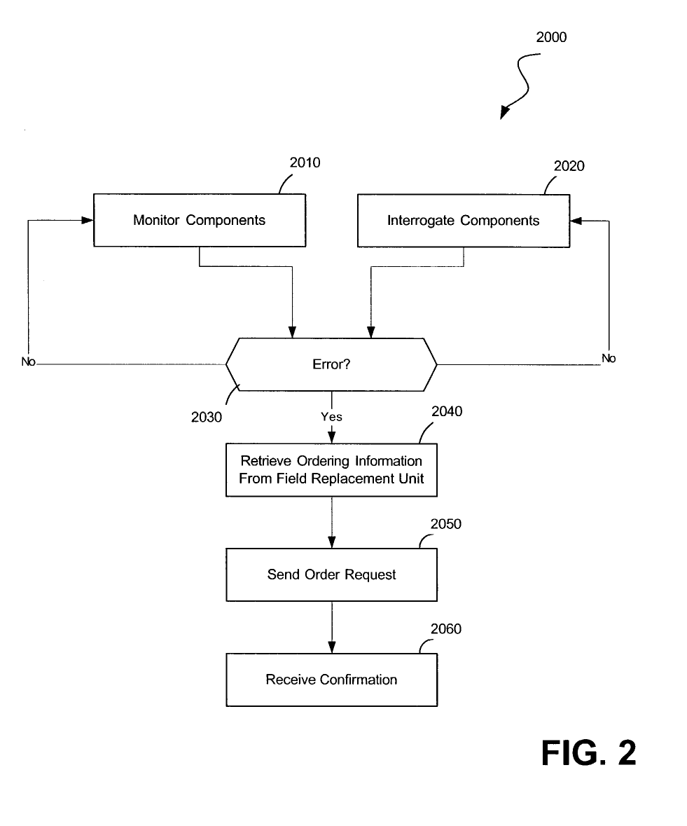

FIG. 2 is a flowchart depicting a method 2000, in accordance with embodiments of the present invention. According to the method, the manager may monitor reports from various components throughout the computer platform (block 2010). Alternatively, the manager may interrogate other components periodically at predetermined intervals to determine if they are functioning properly (block 2020). Each component may notify the manager by sending an alert signal when any error is detected. Typically, when no errors are detected, the manager repeats the operations of blocks 2010-2030 periodically on a shared basis with other platform operations.

When an error is detected (block 2030), the manager may identify a malfunctioning component. The manager may then refer to the FRU information to retrieve ordering information associated with the malfunctioning component (block 2040). According to one embodiment, the ordering information may include a product identification code such as a manufacturer ID, a product ID and a model number. In another embodiment, the ordering information also may include a network address for each component identified in the FRU information. Other information associated with the malfunctioning component also could be included to fit ordering requirements of a SMS 150 (FIG. 1).

After retrieving the associated data regarding the malfunctioning component, the manager may generate and transmit an order request to the SMS (block 2050). The order request may be for replacement of the malfunctioning component. Also, the order may be for manual service on the malfunctioning component. If the SMS receives and processes the order request correctly, it may return a confirmation message to the manager (block 2060). Upon receipt of the confirmation message, the method may conclude. Of course, if a confirmation message is not received within a predetermined amount of time, additional order request transmissions may be attempted (not shown).

According to one embodiment, the order request being sent may have the form of an XML/CGI script via a server. In accordance with another embodiment, the Internet is used to provide communication between the system and the supply and maintenance service. However, other known means of communication, such as a pager, an e-mail and/or a local system server, may also be used so long as they can transmit to SMS 150.

The confirmation may be in the form of an XML/HTML script. As mentioned previously, other known types of communication means may also be used to send a confirmation. The confirmation may include a manufacturer ID, a manufacturer name, a product ID, a product name, a part number, a serial number, a model number, an instruction and diagram for replacing the malfunctioning component, and the like.

As noted above, in one embodiment, for each component listed in the FRU information, the FRU information may include an address of an SMS to which an order request should be transmitted. Thus, in this embodiment, the order request transmission may be attempted using addressing information contained in the FRU information. This permits different SMS service provider to be identified for different components within a single computer platform. Thus, if a first vendor provided a magnetic disk drive used in the platform and a second vendor provided a power supply used therein, orders replacement parts may be sent to SMS services for each vendor. In an alternate embodiment, the FRU information or the manager may store information representing a default address to be used either for all part ordering or in the event that the FRU information does not store a vendor-specific address for a particular component.

The system adapting the method shown in FIG. 2 continuously monitors the operation of each of the plurality of components by repeating operations shown in block 2010-block 2030. The maintenance function or operations shown in block 2040-block 2060 (i.e., identifying the malfunctioning component, and automatically and autonomously ordering the malfunctioning component) is triggered when the sensor detects improper operations of any components. According to embodiments, the predetermined threshold ranges of the components are preset broadly, so that the apparatus only focuses on major improper operations of the components. However, based on the desired reliability of the system, the threshold ranges may be defined narrowly to enhance the accuracy of the operation. In accordance with one embodiment, a component is hardware. However, a component may be software, hardware, or a combination thereof.

As noted, the principles of the present invention find application in computer platforms of a variety of types and architectures. They may find application in relatively small platforms, such as individual personal computers or laptop computers, and also in larger platforms such as a network of computer servers. The following discussion explains operation of the foregoing embodiments in connection with two exemplary computer platforms.

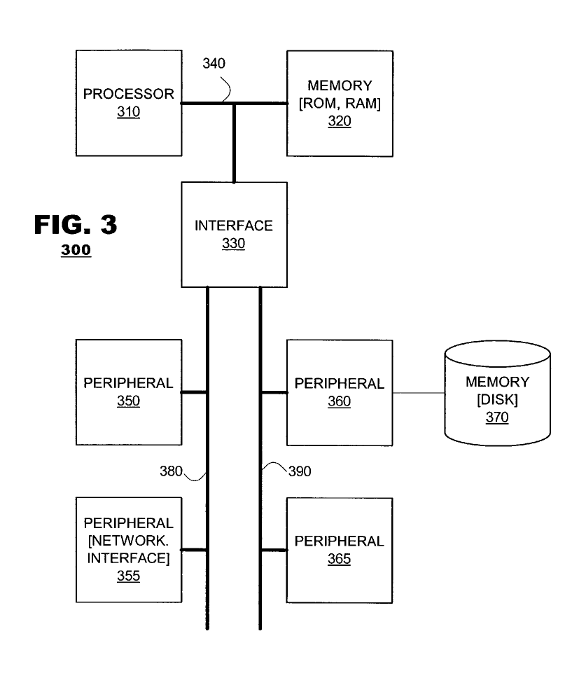

FIG. 3 is a simplified block diagram of a first exemplary computer platform 300 suitable for use with the present invention. As shown the platform 300 may include a processor 310, a memory system 320 and interface 330 all interconnected via first communication links 340. The platform further may include a plurality of peripheral components 350, 355, 360 and 365 interconnected to the interface 330 via respective communication links 380, 390. One of the peripherals is shown as including disk memory 370. Another peripheral 355 is shown as network interface, permitting communication between the platform and an external communication network. A modern computer platform typically includes many additional components and communication links for exchange of data therebetween but the illustration of FIG. 3 is sufficient to explain operation of the foregoing embodiments.

The processor 310 may execute operating system software and, in so doing, may exchange data between itself and the memories 320, 370. The sensor data records 120 and FRU information 130 of FIG. 1 may be distributed among the memories 320, 370 under conventional memory control processes as dictated by the operating system. To interrogate one or more components, such as may be desired to determine the operational state of the component, the processor may institute communication with the component via the communication links 340, 380, 390 that are provided within the platform.

Thus, in the system of FIG. 3, software management processes may be executed by the manager to identify failing components and to generate and transmit order requests via an external network.

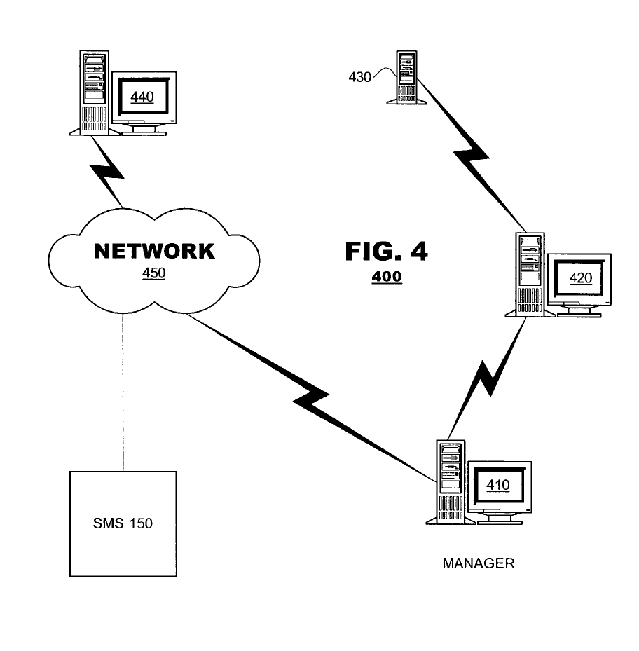

FIG. 4 illustrates a second exemplary computer platform 400 suitable for use with the foregoing embodiments of the present invention. This platform 400 is shown as a networked server system in which a plurality of computer servers 410-440 are integrated as a networked system. In one embodiment, management and parts ordering may be performed independently by each server 410-440. In this case, the operation of the server may occur as shown above in FIG. 3.

In a second embodiment, one of the servers (say, server 410) may be designated to operate as a manager for the entire network 400. Each server 410-440 may identify events from its own components and, when they occur, the server may report the event to the manager within the designated server 410. Thus, the designated server 410 may diagnose the events to determine whether a component is failing and, if so, generate an order for a replacement part. In this embodiment, the FRU may be stored at the designated server 410 and may include component information for all servers in the network 400.

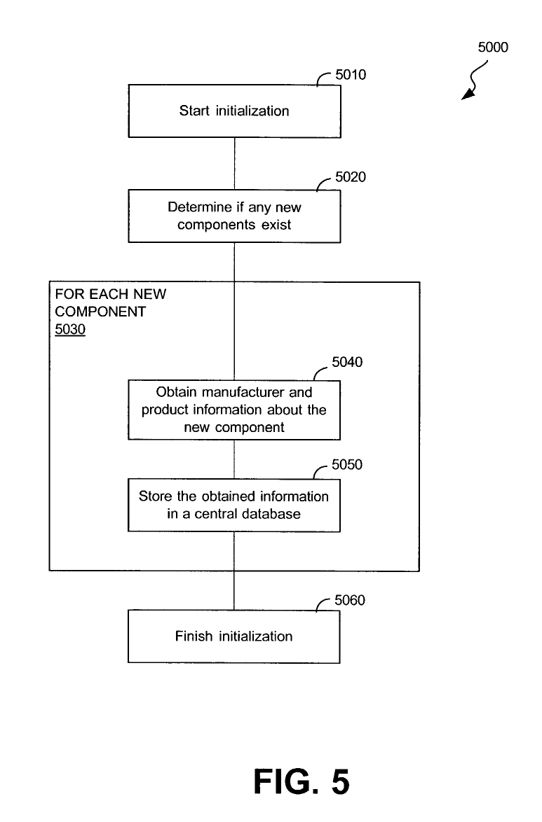

FIG. 5 illustrates a method 5000 for building FRU information in accordance with embodiments of the present invention. When a system implementing the method 5000 is powered on or otherwise triggered, a server awakes from its dormant state and starts initialization of the associated system (block 5010). Conventionally, an operating system in the platform interrogates various system components to determine if the components have been replaced since the platform was last used (block 5020). According to an embodiment, a manager may work cooperatively with this process and, when it is determined that a new component ha been added to the platform (block 5030), the manager may interrogate the new component to retrieve therefrom ordering information (block 5040). Thus, the manager may download from the new component the manufacturer ID, product ID and possibly the addressing information referenced above. This ordering information may be stored in the FRU (block 5050), possibly overwriting old information associated with a component that had been removed from the platform, if any was detected. This embodiment provides an advantage because it stores ordering information of a component independently from the component itself. If the component fails and ordering information could not be retrieved therefrom, the ordering information may be available to the manager in the FRU information. The manager completes initialization of the system (block 5060).

Several embodiments of the present invention are specifically illustrated and described herein. However, it will be appreciated that modifications and variations of the present invention are covered by the above teachings and within the purview of the appended claims without departing from the spirit and intended scope of the invention.

What is claimed is:

1. An apparatus, comprising:
a plurality of hardware components;
a memory to store ordering information of the hardware components, a processor to identify a malfunctioning component among the plurality of components and, responsive to such identification, to retrieve from the database the ordering information associated with the malfunctioning component and to generate a product order;
a communication apparatus to transmit the product order to a supply and maintenance service.

2. The apparatus of claim 1, further comprising a sensor to monitor the plurality of components for determining whether each component is operating properly.

3. The apparatus of claim 2, further comprising a sensor data record to maintain a log of each component monitored by a manager.

4. The apparatus of claim 1, wherein the ordering information comprises a manufacturer identification number, a product identification number, a serial number, a part number and a model number.

5. The apparatus of claim 1, wherein the processor core sends, along with the product order, the ordering information associated with the malfunctioning component to the supplier.

6. The apparatus of claim 1, wherein the processor core and the plurality of components reside within multiple chassis of a network system.

7. The apparatus of claim 1, wherein the processor core and the plurality of components reside within a single chassis.

8. The apparatus of claim 1, wherein the supplier sends a response to the processor core via the server after receiving the order from the processor core.

9. The apparatus of claim 7, wherein the response comprises a manufacturer name, a manufacturer identification number, a product name, a product identification number, a part number, a model number, and instructions and diagrams for replacing the ordered part.

10. A method of performing an administrative and maintenance task, comprising:
providing a plurality of components;
detecting a malfunctioning component among the plurality of components;
locating ordering information associated with the malfunctioning component; and
generating a product order to replace the malfunctioning component with a supplier via a server, wherein the product order further includes the ordering information associated with the malfunctioning component.

11. The method of claim 10, wherein the detecting a malfunctioning component further comprises monitoring each of the plurality of components further and measuring a sensor value associated with the component using a sensor.

12. The method of claim 11, wherein the detecting a malfunctioning component further comprises determining whether the sensor value associated with one of the component violates a set of predetermined threshold values.

13. The method of claim 10, wherein the plurality of components reside within multiple chassis in a network system.

14. The method of claim 10, wherein the product order is a replacement hardware supply request.

15. A multi-component system, comprising:
a plurality of components interconnected via a common bus;
at least one component comprising a processor core, monitoring the plurality of components, identifying a malfunctioning component and communicating with a server to generate a parts order for a replacement of the malfunctioning component; and
at least one component comprising a server, communicating with a service to place the order when the error condition is detected, the service being devoid of direct connection to the multi-component system and sending a response in reply to the parts order placed.

16. The system of claim 15, further comprising at least one other component comprising a system memory, maintaining manufacturer and production information associated with each of the plurality of components.

17. A network comprising:
a plurality of components performing different operations, each of the plurality of components having a predetermined threshold range;
a host computer to monitor the plurality of components, to determine whether any component is violating the predetermined threshold range, and to identify a malfunctioning component among the plurality of components; and
a network server, providing communication between the host computer and a service to generate a product order for replacement of the malfunctioning component, the service sending a response in reply to the product order generated.

18. The network of claim 17, wherein each of the malfunctioning component is a hardware.

19. A computer readable medium storing program instructions that, when executed by a processor, cause the processor to:
diagnose event data related to a component to determine if the component is failing,
if the component is determined to be failing, retrieve ordering information and an address from a memory, and
transmit an order request to a network location identified by the address, the order request identifying information of a replacement component.

20. The computer of claim 19, wherein the ordering information further comprises product information and manufacturer information.
